(19) United States
(12) Patent Application Publication
(10) Pub. No.: US 2014/0129594 A1
(43) Pub. Date: May 8, 2014

(54) BOUNDS FOR GRAPH BISECTION

(71) Applicant: MICROSOFT CORPORATION, Redmond, WA (US)

(72) Inventors: Daniel Delling, Mountain View, CA (US); Renato F. Werneck, San Francisco, CA (US)

(73) Assignee: Microsoft Corporation, Redmond, WA (US)

(21) Appl. No.: 13/668,312

(22) Filed: Nov. 4, 2012

(51) Int. Cl. G06F 17/30

(52) U.S. Cl. 707/797; 707/798; 707/E17.044

(57) ABSTRACT

Techniques are described for graph partitioning, and in particular, graph bisection. A combinatorial lower bound is provided that is computed in near-linear time. These bounds may be used to determine optimum solutions to real-world graphs with many vertices (e.g., more than a million for road networks, or tens of thousands for VLSI and mesh instances). Combinatorial techniques that reduce the size of the branch-and-bound search tree may use tree packing, assign vertices to trees, and use fractional assignment of vertices to trees. For graph bisection, each node of the branch-and-bound tree corresponds to a partial assignment of vertices to both cells or sets of vertices.

### BACKGROUND

The minimum graph bisection problem is a well known problem that seeks to partition a graph into two equally-sized cells while minimizing the number of edges between them. More particularly, the input to the minimum graph bisection problem is an undirected, unweighted graph G=(V, E), and its goal is to partition V into two sets or cells A and B such that |A|, |B|≦┌|V|/2┐, and the number of edges between cells A and B (the cut size) is minimized. This combinatorial optimization problem is a case of graph partitioning which asks for arbitrarily many cells. It has many applications, including image processing, computer vision, divide-and-conquer algorithms, VLSI circuit layout, distributed computing, and route planning.

Known software libraries (e.g., METIS, SCOTCH, JOSTLE, etc.) solve the graph partitioning problem but the quality of the obtained solutions is often unacceptable. Heuristics directed to particular graph classes, such as DibaP (for meshes) and PUNCH (for road networks), are also known. These techniques cannot prove optimality or provide approximation guarantees, and do not perform well unless imbalance is allowed.

There is much literature on computing exact solutions to the graph bisection and partitioning problems, mostly using the branch-and-bound framework. These techniques can only solve instances of moderate size (with hundreds or a few thousand vertices) to optimality, even after a few hours of processing.

### SUMMARY

Techniques are described for graph partitioning, and in particular, graph bisection. A combinatorial lower bound is provided that is computed in near-linear time. These bounds may be used to determine optimum solutions to real-world graphs with many vertices (e.g., more than a million for road networks, or tens of thousands for VLSI and mesh instances).

In various implementations, combinatorial techniques to reduce the size of the branch-and-bound search tree may use tree packing, assign vertices to trees, and use fractional assignment of vertices to trees.

In an implementation, lower bounds for the minimum graph bisection problem, within a branch-and-bound framework, enable the solution of a wide variety of instances with tens of thousands of vertices to optimality. The techniques are combinatorial. For graph bisection, each node of the branch-and-bound tree corresponds to a partial assignment of vertices to both cells. It is determined by the lower bound early in the process that certain partial assignments cannot lead to the optimum bisection.

This summary is provided to introduce a selection of concepts in a simplified form that are further described below in the detailed description. This summary is not intended to identify key features or essential features of the claimed subject matter, nor is it intended to be used to limit the scope of the claimed subject matter.

### BRIEF DESCRIPTION OF THE DRAWINGS

The foregoing summary, as well as the following detailed description of illustrative embodiments, is better understood when read in conjunction with the appended drawings. For the purpose of illustrating the embodiments, there are shown in the drawings example constructions of the embodiments; however, the embodiments are not limited to the specific methods and instrumentalities disclosed. In the drawings:

FIG. 1 shows an example of a computing environment in which aspects and embodiments may be potentially exploited;

FIG. 2 is an operational flow of an implementation of a method which may be used in graph partitioning;

FIG. 3 is an operational flow of an implementation of a method which may be used in processing each subproblem in the branch-and-bound technique;

FIG. 4 is an operational flow of an implementation of a method of computing bounds;

FIG. 5 is an operational flow of an implementation of a method of determining a valid tree packing for use in computing bounds;

FIG. 6 is an operational flow of an implementation of a method of allocating vertex weights to trees for use in computing bounds;

FIG. 7 is an operational flow of an implementation of a method of performing flow-based forced assignments;

FIG. 8 is an operational flow of an implementation of a method of performing subdivision-based forced assignments;

FIG. 9 is an operational flow of an implementation of a method of processing each node of a branch-and-bound tree;

FIG. 10 is an operational flow of an implementation of a method of determining a minimum bisection of a graph; and

FIG. 11 shows an exemplary computing environment.

### DETAILED DESCRIPTION

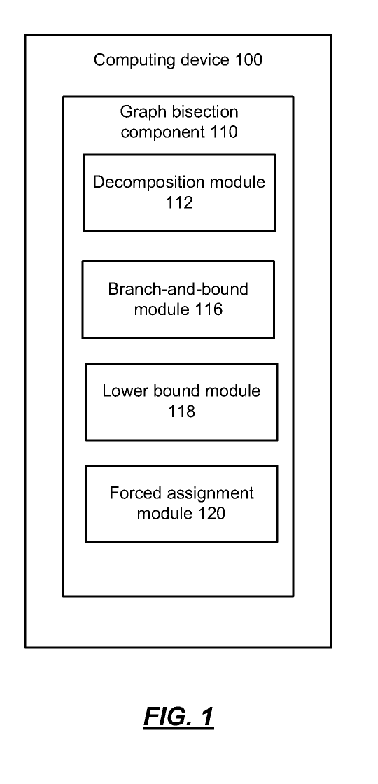

FIG. 1 shows an example of a computing environment in which aspects and embodiments may be potentially exploited. A computing device 100 includes a network interface card (not shown) facilitating communications over a communications medium. Example computing devices include personal computers (PCs), mobile communication devices, etc. In some implementations, the computing device 100 may include a desktop personal computer, workstation, laptop, smart phone, PDA (personal digital assistant), cell phone, or any WAP-enabled device or any other computing device capable of interfacing directly or indirectly with a network. An example computing device 100 is described with respect to the computing device 1100 of FIG. 11, for example.

The computing device 100 comprises a graph bisection component 110 which may perform the graph partitioning described herein. Although implementations described herein are directed to graph bisection, it is contemplated that the techniques described herein may be used to partition a graph into any number of sections or partitions.

As described further herein, bounds are determined for the minimum graph bisection problem, which is known to be NP-hard. To solve this problem, an implementation is based on the known branch-and-bound framework. For graph bisection, each node of the branch-and-bound tree corresponds to a partial assignment of vertices to both cells (e.g., cells A and B). A combinatorial bound is determined by building collections of disjoint paths. Moreover, some vertices may be fixed to one of the cells without actually branching on them.

The graph bisection component 110 may comprise modules that perform various techniques described herein. A decomposition module 112 may be used to reduce an input graph into multiple subproblems that are less complex to solve. A branch-and-bound module 116 uses the branch-and-bound technique, generating a search tree to solve the graph bisection problem. A lower bound module 118 may be used to compute lower bounds for each subproblem and a forced assignment module 120 may be used to force vertex assignments, as described further herein.

The modules of the graph bisection component 110 may be used independently of each other, or in conjunction with each other, depending on the implementation, and may perform various alternative and/or additional techniques as described further herein.

The computing device 100 may communicate with a local area network (not shown) via a physical connection. Alternatively, the computing device 100 may communicate with the local area network via a wireless wide area network or wireless local area network media, or via other communications media. The network may be a variety of network types including the public switched telephone network (PSTN), a cellular telephone network (e.g., 3G, 4G, CDMA, etc), and a packet switched network (e.g., the Internet). Any type of network and/or network interface may be used for the network. The user of the computing device 100, as a result of the supported network medium, is able to access network resources, typically through the use of a browser application running on the computing device 100. The browser application facilitates communication with a remote network over, for example, the Internet.

As described further herein, the graph bisection component 110 can perform graph partitioning (e.g., bisecting) and provide results to the graph partitioning problem on any graph. The term “cut” is used herein to denote a set of edges that separates the graph into two or more regions. It is contemplated that graph partitioning as described herein may be used with any application requiring balanced graph cuts, i.e., cuts in which the regions have (approximately) the same size.

To visualize methods contemplated herein, it is helpful to represent the input (an abstract graph with vertices and undirected edges) as points with connecting segments. Vertices may correspond to locations or points, and edges may correspond to segments between locations. The edges may be weighted according any criteria about the corresponding segment. For manipulation by computing devices, graphs may be stored in a contiguous block of computer memory as a collection of records, each record representing a single graph node or edge along with associated data.

As used herein, G=(V, E) denotes an input graph, with n=|V| vertices and m=|E| edges. Each vertex v∈V may have an associated integral weight, denoted by w(v), and each edge e∈E has an associated integral cost c(e). W denotes the sum of all the integral weights. A partition of G is a partition of V, i.e., a set of subsets of V which are disjoint and whose union is V. Each such subset is referred to as a cell, whose weight is defined as the sum of the weights of its vertices. The cost of a partition is the sum of the costs of all edges whose endpoints belong to different cells. A bisection is a partition into two cells (such as cells A and B). A bisection is ε-balanced if each cell has weight at most (1+ε)┌W/2┐. If ε=0, the partition is balanced. The minimum graph bisection problem is that of finding the minimum-cost balanced bisection. A minimum ε-balanced bisection of a graph G may be defined as a partition of V into exactly two sets (cells) such that (1) the weight of each cell is at most W₊=└(1+ε)┌W/2┐┘, and (2) the number of edges between cells (cut size) is minimized. Conversely, W₋=W−W₊ is the minimum allowed cell size.

Unless otherwise noted herein, the unweighted, balanced version of the problem is considered, where w(v)=1 for all v∈V, c(e)=1 for all e∈E, and ε=0. The graph G is therefore partitioned into two cells A and B, each with weight at most ┌n/2┐, while minimizing the number of edges between cells. These techniques can be generalized to handle less restricted inputs, such as arbitrary weights and imbalance.

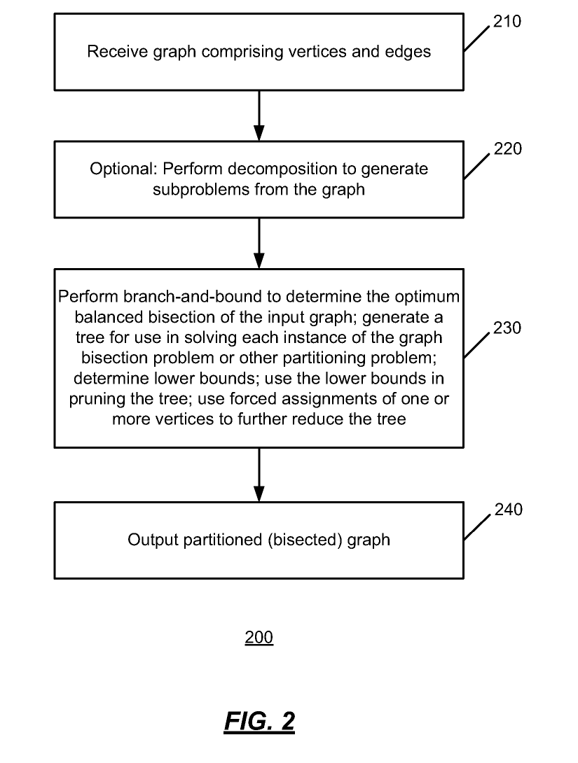

FIG. 2 is an operational flow of an implementation of a method 200 which may be used in graph partitioning. At 210, an input graph G=(V,E) is received at the computing device 100. The input graph may be received from storage and/or a user or system administrator. Decomposition is optional and may be performed on the input graph at 220. As described further herein, decomposition may be used to generate subproblems of the original graph bisection (or partitioning) problem using the input graph. The decomposition technique generates a number of different graphs. Each of those graphs is provided to the branch-and-bound algorithm that solves the nodes of the tree, either pruning at the node (if the lower bound L is greater than or equal to the upper bound U), or branching into two new nodes of the tree. Hence there are two kinds of subproblems: those generated by the decomposition, and those generated during the branch-and-bound process. Decomposition is an optional preprocessing step.

At 230, a branch-and-bound technique is used to determine the optimum balanced bisection of the input graph. The branch-and-bound technique is used to generate a tree for use in solving each instance of the graph bisection problem (or other partitioning problem). The branch-and-bound technique may determine lower bounds, use the lower bounds in pruning the tree, and may use forced assignments of one or more vertices to further reduce the tree. An optimum balanced bisection of the vertices of the graph may thus be determined. At 240, the partitioned (i.e., bisected) graph may be outputted (e.g., provided to the user and/or storage and/or an application for processing).

Branch-and-bound is a technique that performs an implicit enumeration by dividing a problem into two or more simpler subproblems, solving them recursively, and picking the best solution found. Each node of a branch-and-bound tree corresponds to a distinct subproblem. In a minimization context, the technique keeps a global upper bound U on the solution of the original problem, which can be updated as the algorithm determines improved solutions. To process a node in the tree, first compute a lower bound L on any solution to the corresponding subproblem. If the lower bound L is greater than or equal to the upper bound U, prune the node because it cannot lead to a better solution. Otherwise, branch to create two or more simpler subproblems.

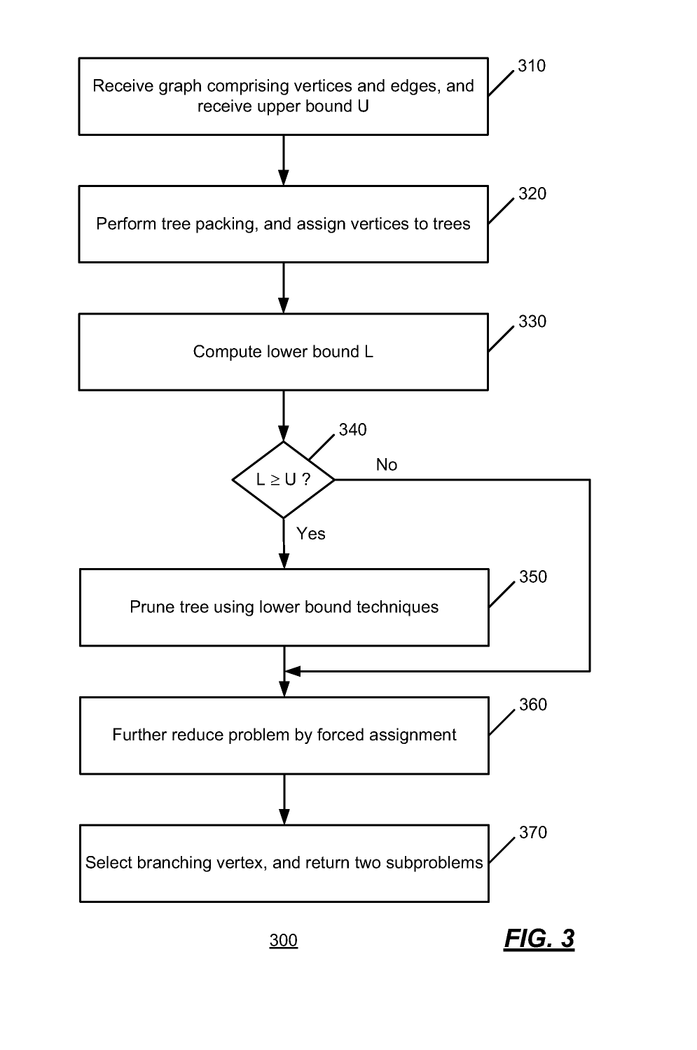

More particularly, FIG. 3 is an operational flow of an implementation of a method 300 which may be used in processing each subproblem in the branch-and-bound technique. At 310, a graph G=(V,E) is received, along with an upper bound U and a partial assignment (A,B). At 320, perform tree packing and assign vertices to trees, as described further herein.

Lower bounds may be determined and the branch-and-bound tree may be pruned. Thus, at 330, compute the lower bound L using techniques described herein for example. At 340, it is determined whether the lower bound L is greater than or equal to the upper bound U. If so, then the node of the tree is pruned at 350. Otherwise, at 360, further vertices in the graph may be assigned to A and B using forced assignments (i.e., the problem may be further simplified using forced assignments of one or more vertices). At 370, a branching vertex v is selected, and two subproblems (A, B+v) and (A+v, B) are returned (where A and B correspond to the two sets of assigned vertices, respectively).

In an implementation, for each subproblem created by the decomposition, multiple calls to a function “Solve” may be used to process each individual subproblem. Let S be the set of open subproblems available (initially containing a single problem). While S is not empty, call the function “Solve” on S (referred herein as “Solve(S)”). Solve(S) is defined as follows: (1) remove a problem P from S, (2) compute a lower bound for P, (3) if P is at least as high as the best known U upper bound, return, (4) perform forced assignments, and (5) pick a branching node v, generate two subproblems of P (assigning vertex v to set A or set B), and add them both to S.

In the case of graph bisection, each node of a branch-and-bound tree corresponds to a partial assignment (A, B), where A, B⊂V and A∩B=Ø. The vertices already fixed to sets A or B are assigned, and all others are free (or unassigned). This node represents the valid bisections (A⁺, B⁺) that are extensions of (A, B), i.e., such that A⊂A⁺ and B⊂B⁺. In particular, the root node, which represents all valid bisections, has the form (A, B)=({v}, Ø). Note that the root can fix an arbitrary vertex v to one set to break symmetry.

To process an arbitrary node (A, B), a lower bound L(A, B) is computed on the value of any extension (A⁺, B⁺) of (A, B). In an implementation, combinatorial bounds are used. In particular, the well-known flow bound may be used: the minimum s-t cut (maximum s-t flow) between set A and set B. It is a valid lower bound because any extension (A⁺, B⁺) separates A from B. If the minimum cut s-t is balanced, the node can be pruned and the upper bound U may be updated. Otherwise, a free vertex v may be chosen and branched on, generating subproblems (A∪{v}, B) and (A, B∪{v}).

The flow lower bound works well when A and B have similar sizes; even in this case, however, the corresponding minimum cuts are often far from balanced, with one side containing many more vertices than the other. This makes the flow bound weak by itself. To overcome these issues, an edge-based packing bound may be used.

To take the balance constraint into account, a lower bounding technique is described, referred to herein as an edge-based packing bound. Consider a partial assignment (A, B). Let f be the value of the maximum A-B flow, and G_{f} be the graph obtained by removing all flow edges from graph G. Without loss of generality, let set A be the main side, i.e., the set of vertices reachable from set A in G_{f} has higher total weight than those reachable from B. The new bound on G_{f} is computed, and this can be added to f to obtain a unified lower bound.

To compute the bound, a collection of trees T is determined. This collection of trees T may be referred to as a tree packing T and is a collection of trees (acyclic connected subgraphs of G_{f}) such that: (1) the trees are edge-disjoint; (2) each tree contains exactly one edge incident to set A; and (3) the trees are maximal (no edge can be added to T without violating the previous properties). Given a set S⊂V, let T(S) be the subset of T consisting of all trees that contain a vertex in S. By extension, let T(v)=T ({v}).

The building of a tree packing T is described further below. With T, it can be reasoned about any extension (A⁺,B⁺) of (A,B). By definition, a tree Tᵢ∈T contains a path from each of its vertices to A; if a vertex in B⁺ is in Tᵢ, at least one edge from Tᵢ must be cut in (A⁺,B⁺). Since each tree Tᵢ∈T(B⁺) contains a separate path from A to B⁺ in G_{f}, the following holds: If B⁺ is an extension of B, then f+|T(B⁺)| is a lower bound on the cost of the corresponding bisection (V\B⁺,B⁺).

This applies to a fixed extension B⁺ of B. A lower bound is determined that applies to all (exponentially many) possible extensions. A worst-case extension B* (i.e., one that minimizes the bound) may be determined. First, note that w(B*)≧W₋, since the bisection (V\ B*,B*) is a valid bisection. Second, let D_{f}⊂V be the set of all vertices that are unreachable from A in G_{f} (in particular, B⊂D_{f}). Without loss of generality, let B* contain D_{f}. Any vertex v∈D_{f} is deadweight: since there is no path from v to A, it does not contribute to the lower bound.

To reason about other vertices in B*, establish a relationship between T and vertex weights by predefining a vertex allocation, i.e., a mapping from vertices to trees. Allocate each reachable free vertex v (i.e., v∈V\(D_{f}∪A)) to one of the trees in T (v), as described further below. The weight w(Tᵢ) of a tree Tᵢ∈T is the sum of the weights of all vertices allocated to Tᵢ.

Given a fixed allocation, without loss of generality, if B* contains a single vertex allocated to a tree Tᵢ, it will contain all vertices allocated to Tᵢ. This is because the first vertex increases the lower bound by one unit, but the other vertices in the tree are free.

Moreover, B* contains a feasible set of trees T′⊂T, i.e., a set whose total weight w(T′) (defined as Σ_{Tiεt′}w(Tᵢ)) is at least as high as the target weight W_{f}=W₋−w(D_{f}). Since B* is the worst-case extension, one must pick a feasible set T′ of minimum cardinality. Formally, given a partial assignment (A,B), a flow f, a tree packing T, and an associated vertex allocation, define the packing bound p(T) as the minimum |T′| such that T′⊂T and w(T′)≧W_{f}. Note that this bound can be computed by a greedy algorithm, which picks trees in decreasing order of weight until their accumulated weight is at least W_{f}.

This bound may be strengthened by allowing fractional allocations. Instead of allocating v's weight to a single tree, distribute w(v) arbitrarily among all trees in T(v). For v's allocation to be valid, each tree receives a nonnegative fraction of v's weight, and these fractions add up to one. The weight of a tree T is defined as the sum of the fractional weights allocated to T. Fractional allocations can improve the packing bound by making trees more balanced. They are particularly useful when the average number of vertices per tree is small, or when some vertices have high degree.

Thus, it is determined that considering a partial assignment (A,B), a flow f, a tree packing T, and a valid fractional allocation of weights, then f+p(T) is a lower bound on the cost of any valid extension of (A,B).

The packing bound is a generalization of a previous known bounding technique, which also creates a set of disjoint trees and uses a greedy packing algorithm to compute a lower bound. A difference is that, while with the present techniques the trees are edge-disjoint, the previous known techniques require them to be vertex-disjoint. Thus, the previous known techniques are referred to herein as VBB (for vertex-based bound). Dropping vertex-disjointness not only allows the present techniques to balance the trees more effectively (since they can allocate vertex weights more flexibly), but also increases the number of available trees. This results in significantly better lower bounds, leading to much smaller branch-and-bound trees.

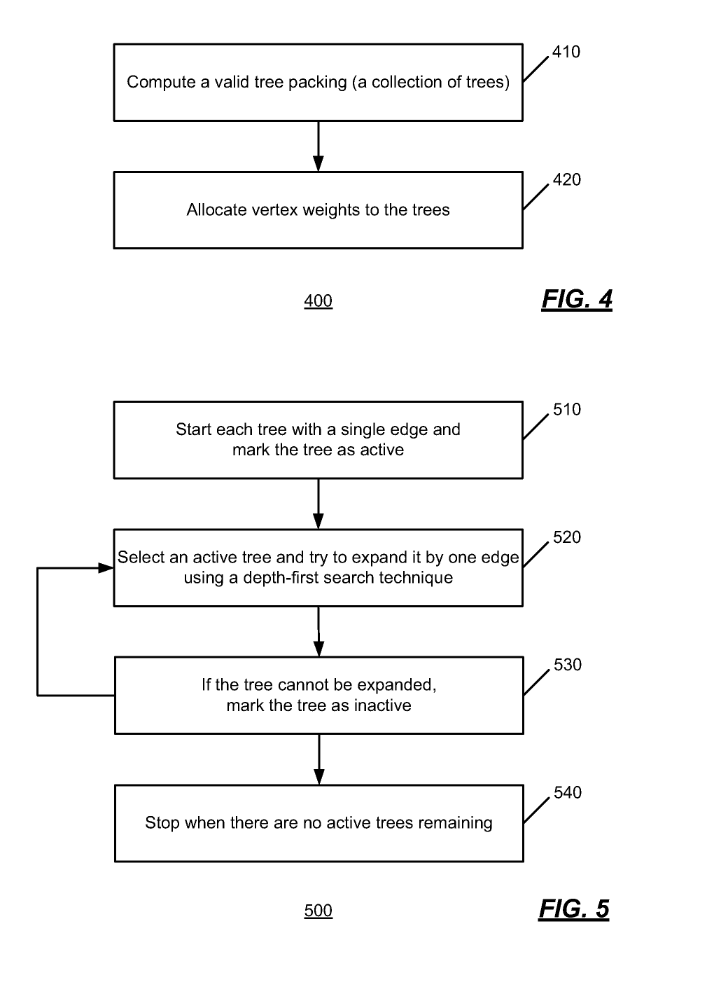

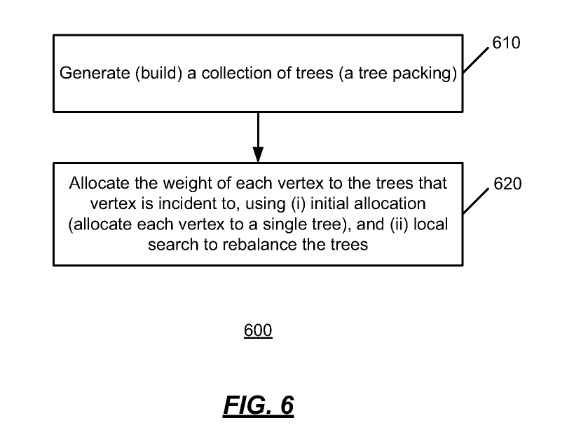

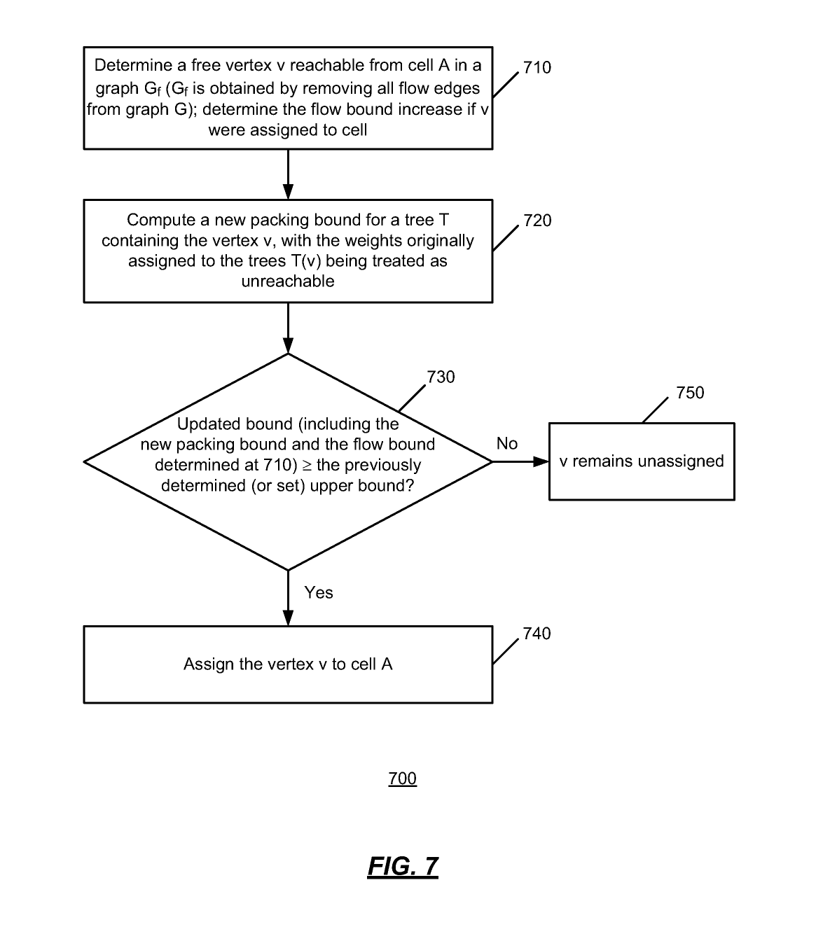

Regarding bound computation, in an implementation, a two-stage approach is used for determining trees and weight allocations. FIG. 4 is an operational flow of an implementation of a method 400 of computing bounds for use in edge-based packing. At 410, compute a valid tree packing, and at 420 allocate vertex weights to these trees appropriately. As described further below, FIG. 5 is an operational flow of an implementation of a method 500 of determining a valid tree packing for use in computing bounds, and FIG. 6 is an operational flow of an implementation of a method 600 of allocating vertex weights to trees for use in computing bound.

With regard to generating trees, the first stage generates maximal edge-disjoint trees rooted at A that are as balanced and intertwined as possible. This may be done by growing these trees simultaneously, trying to balance their sizes.

More precisely, at 510, each tree starts with a single edge (the one adjacent to the cell A) and is marked active. At 520, in each step, pick an active tree with minimum size (number of edges) and try to expand it by one edge in a DFS (depth-first search) manner. A tree that cannot be expanded is marked as inactive at 530. At 540, stop when there are no active trees left. This technique is referred to as SDFS (simultaneous depth-first search).

An efficient implementation of SDFS uses a careful choice of data structures. In particular, a standard DFS implementation associates information (such as parent pointers and status within the search) with vertices, which are the entities added and removed from the DFS stack. In contrast, during SDFS the same vertex may be in several trees (and stacks) simultaneously. To handle this, associate information with edges instead. Since each edge belongs to at most one tree, it has at most one parent and is inserted into at most one stack.

Given this representation, an operation of SDFS is described in more detail. First, pick an active tree Tᵢ of minimum size (using buckets or a priority queue, for example). Let (u, v) be the edge on top of Sᵢ (the stack associated with Tᵢ), and assume v is farther from Tᵢ's root than u is (considering distances within the tree itself). Scan vertex v, looking for an expansion edge. This is an edge (v,w) such that (1) (v,w) is free (not assigned to any tree yet) and (2) no edge incident to w belongs to Tᵢ. The first condition ensures that the final trees are disjoint, while the second makes sure they have no cycles. If no such expansion edge exists, pop (u,v) from Sᵢ; if Sᵢ becomes empty, Tᵢ can no longer grow, so mark it as inactive. If expansion edges do exist, pick one such edge (v,w), push it onto Sᵢ, and add it to Tᵢ by setting parent (v,w)←(u,v). The process repeats until there are no more active trees.

To define which expansion edge (v,w) to select when processing (u,v), use an edge (v,w) such that w has several free incident edges (to help keep the tree growing) and is as far as possible from A (to minimize congestion around the roots, which is also why DFS may be performed). Note that the distances from A to all vertices can be precomputed with a single BFS during initialization.

Regarding weight allocation (i.e., assigning vertex weights to trees), once a tree packing T is built at 610, and at 620 allocate the weight of each vertex v to the trees T(v) it is incident to. The weights are as evenly distributed among the trees as possible. This may be performed in two stages: initial allocation and local search.

The first stage allocates each free vertex to a single tree. Maintain, for each tree Tᵢ, its maximum potential weight Π(i), defined as the sum of the weights of all vertices that are adjacent to Tᵢ and have not yet been allocated to another tree. To keep the trees balanced, allocate weight to trees with smaller Π(•) values first. More precisely, initially all vertices in T are available (not allocated), all trees Tᵢ are active, and Π(i) is the sum of the weights of all available vertices incident to Tᵢ. In each step, the algorithm picks an active tree Tᵢ such that Π(i) is minimum. If there is an available vertex v incident to Tᵢ, allocate it to Tᵢ; otherwise, mark the tree as inactive. Stop when no active tree remains.

To implement this, maintain the active trees in a priority queue (according to Π(i)), and each tree Tᵢ keeps a list of all available vertices it is incident to. When v is allocated to a tree Tᵢ, decrease Π(j) for all trees Tⱼ≠Tᵢ that are incident to v (Π(i) does not change), remove v from the associated lists, and update the priority queue.

Given an initial allocation, then run a local search to rebalance the trees. Unlike the constructive algorithm, it allows fractional allocations. Process one vertex at a time (in arbitrary order) by reallocating v's weight among the trees in T(v) in a locally optimal way. More precisely, v is processed in two steps. First, reset v's existing allocation by removing v from all trees it is currently allocated to, thus reducing their weights. Then distribute v's weight among the trees in T(v) (from lightest to heaviest), evening out their weights as much as possible. In other words, add weight to the lightest tree until it is as heavy as the second lightest, then add weight to the first two trees (at the same rate) until each is as heavy as the third, and so on. Stop as soon as v's weight is fully allocated.

Forced assignments are now described. Consider a partial assignment (A,B). If the current lower bound for (A,B) is close enough to the upper bound U, one can often infer that certain free vertices v are to be assigned to A (or B) with no need to branch, reducing the size of the branch-and-bound tree. These forced assignments assign vertices without branching on them, and have been used with other techniques, such as the known VBB. They can be generalized to work with the stronger edge-based bounds. Assume without loss of generality that A is the main side, let T be a tree packing with weight allocations, and let f+p(A) be the current lower bound.

First, consider flow-based forced assignments. FIG. 7 is an operational flow of an implementation of a method 700 of performing flow-based forced assignments. At 710, let v be a free vertex reachable from A in G_{f}, and consider what would happen if it were assigned to B. The flow bound would immediately increase by |T(v)| units, since each tree in T(v) contains a different path from v to A. At 720, compute a new packing bound p(T′), where T′=T\T(v) but the weights originally assigned to the trees T(v) are treated as deadweight (unreachable). At 730, if the updated bound f+p(T′)+|T(v)| is U or higher, it is shown that no solution that extends (A,B∪{v}) can improve the best known solution. Therefore, at 740, assign v to A. Otherwise, at 750, v remains unassigned.

A symmetric argument can be made for vertices w that are reachable from B in G_{f}, as long as an edge packing T′_{B} is computed on B's side. Assigning such a vertex w to A would increase the overall bound by |T′_{B}(w)| (because the extra flow is on B's side, it does not affect p(T)). If the new bound f+p(T)+|T′_{B}(w)| is U or higher, assign w to B.

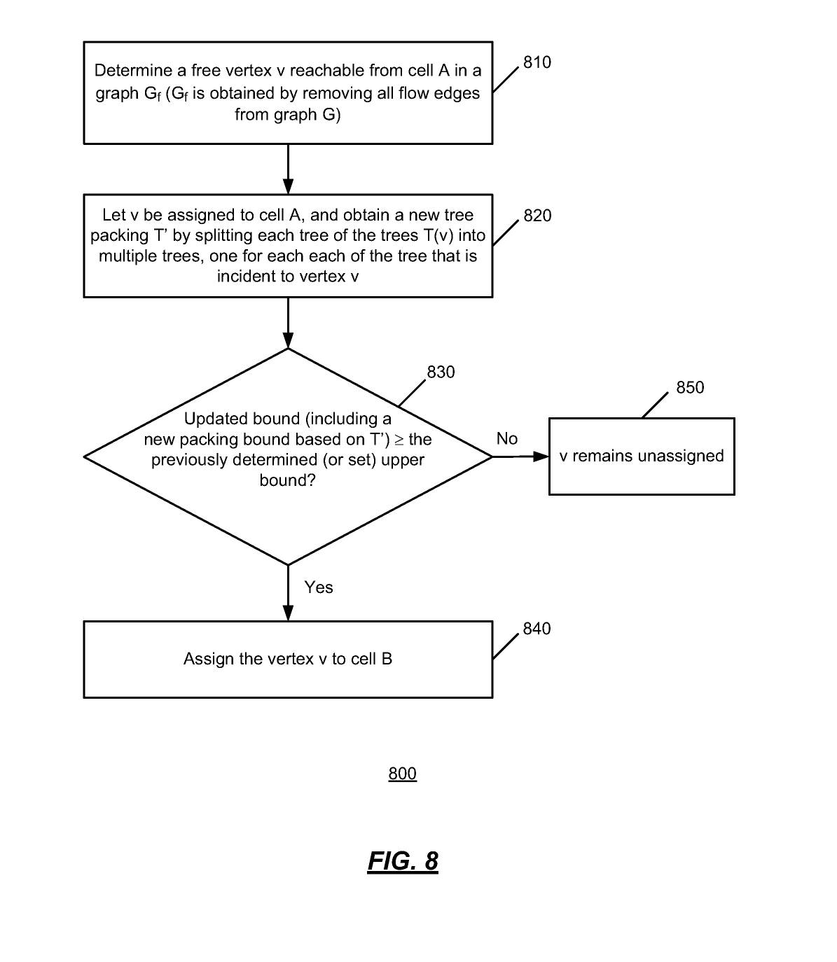

Another technique that may be used is subdivision-based forced assignments, which subdivides heavy trees in T. FIG. 8 is an operational flow of an implementation of a method 800 of performing subdivision-based forced assignments. At 810, let v be a free vertex reachable from A in G_{f}. At 820, if v were assigned to A, a new tree packing T′ may be obtained by splitting each tree Tᵢ∈T(v) into multiple trees, one for each edge of Tᵢ that is incident to v. If f+p(T′)≧U at 830, assign v to B at 840. Otherwise, v remains unassigned at 850.

In an implementation, to recompute the packing bound, compute the total weight allocated to each of the newly-created trees. To do so efficiently, use some precomputation. For each edge e, let T(e)∈T be the tree to which e belongs. Define s(e) as the weight of the subtree of T(e) rooted at e: this is the sum, over all vertices descending from e in T(e), of the (fractional) weights allocated to T(e). If e belongs to no tree, s(e) is undefined. The s(e) values can be computed with a bottom-up traversal of all trees.

These precomputed values are useful when the forced assignment routine processes a vertex v. Each edge e=(v,u) is either a parent or a child edge, depending on whether u is on the path from v to T(e)'s root or not. If e is a child edge, it will generate a tree of size s(e). If e is a parent edge, the new tree will have size s(r(e))-s(e), where r(e) is the root edge of T(e).

Note that both forced-assignment techniques (flow-based and subdivision-based) compute a new packing bound p(T′) for each vertex v they process, which may be costly. In an implementation, an incremental algorithm may be used instead. When computing the original p(T) bound, remember the entire state of its computation (including the sorted list of all original tree weights). To compute p(T′), start from this initial state, discarding trees that are no longer valid and considering new ones appropriately.

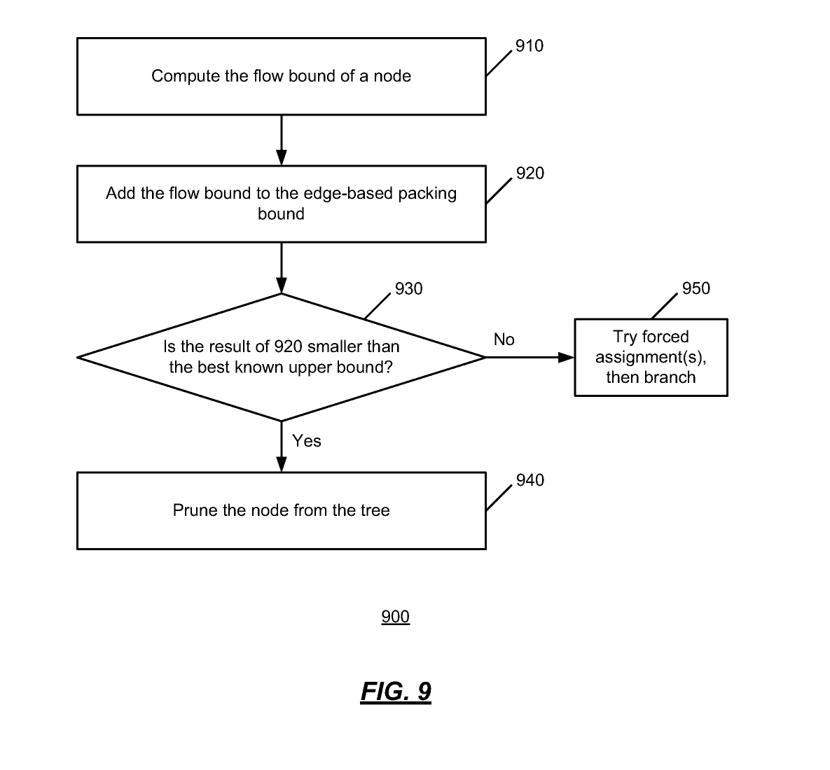

FIG. 9 is an operational flow of an implementation of a method 900 of processing each node of a branch-and-bound tree. At 910, compute the flow bound of the node, then at 920 add to it the edge-based packing bound. At 930, if the result is not smaller than the best known upper bound U, prune the node from the tree at 940. Otherwise, at 950 try both types of forced assignment, then branch.

VBB branches on the free vertex v that maximizes a certain score based on three parameters: the degree of v, the distance from v to A∪B, and the average weight of the trees T(v) that v belongs to. Together, these criteria aim to maximize the overall (flow and packing) bound. Besides these, a fourth criterion may be considered: whenever the current minimum cut A-B is almost balanced, branch on vertices that already carry some flow in order to increase the number of reachable vertices in G_{f}. Different combinations of these (or other) criteria may be considered as well.

Like VBB, only update the best upper bound U when the minimum A-B cut happens to be balanced. Moreover, do not use any heuristics to try to find a good initial bound U. Instead, just call the branch-and-bound algorithm repeatedly, with increasing values of U, and stop when the bound it proves is better than the input.

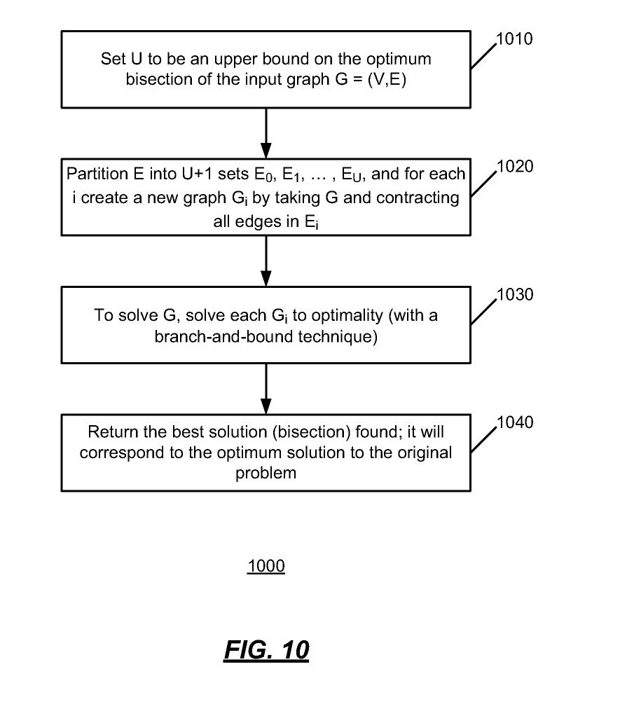

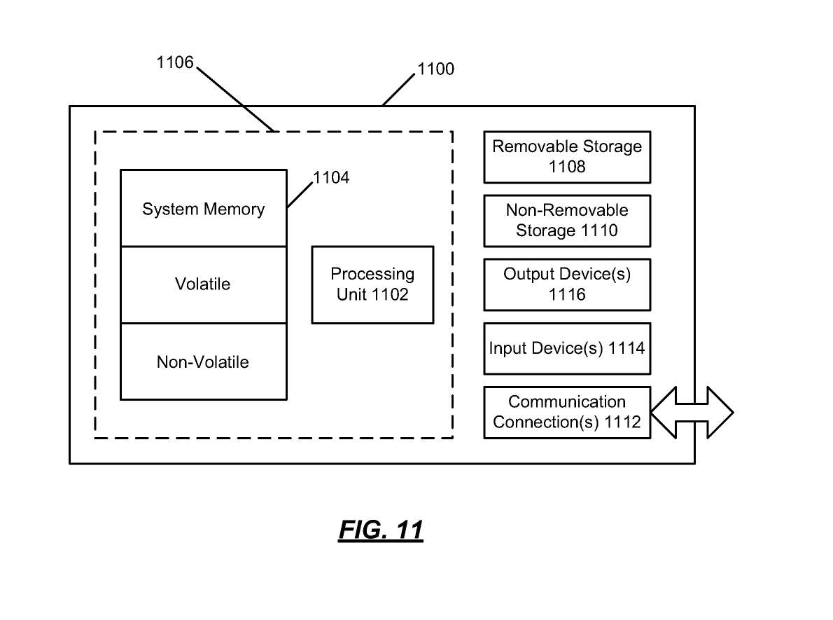

As in VBB, the quality of the lower bounds depends on the degrees of the vertices already assigned to A or B (which limit both the A-B flow and the number of trees). If a graph with small degrees has a large bisection, the branch-and-bound tree can get quite deep. An optional decomposition-based preprocessing technique gets around this. FIG. 10 is an operational flow of an implementation of a method 1000 of determining a minimum bisection of a graph G. At 1010, let U be an upper bound on the optimum bisection of the input graph G=(V,E). At 1020, partition E into U+1 sets E₀, E₁, . . . , E_{U}, and for each i create a new graph Gᵢ by taking G and contracting all edges in Eᵢ. At 1030, to solve G, solve each Gᵢ to optimality (with a branch-and-bound technique), and at 1040 return the best solution (bisection) found. It will correspond to the optimum solution to the original problem. At least one subproblem preserves the optimum solution, since none of the solution edges will be contracted. The edges may be partitioned into clumps (paths with many neighbors) to ensure that, after contraction, each graph Gᵢ will have at least a few high-degree vertices.

FIG. 11 shows an exemplary computing environment in which example implementations and aspects may be implemented. The computing system environment is only one example of a suitable computing environment and is not intended to suggest any limitation as to the scope of use or functionality.

Numerous other general purpose or special purpose computing system environments or configurations may be used. Examples of well known computing systems, environments, and/or configurations that may be suitable for use include, but are not limited to, PCs, server computers, handheld or laptop devices, multiprocessor systems, microprocessor-based systems, network PCs, minicomputers, mainframe computers, embedded systems, distributed computing environments that include any of the above systems or devices, and the like.

Computer-executable instructions, such as program modules, being executed by a computer may be used. Generally, program modules include routines, programs, objects, components, data structures, etc. that perform particular tasks or implement particular abstract data types. Distributed computing environments may be used where tasks are performed by remote processing devices that are linked through a communications network or other data transmission medium. In a distributed computing environment, program modules and other data may be located in both local and remote computer storage media including memory storage devices.

With reference to FIG. 11, an exemplary system for implementing aspects described herein includes a computing device, such as computing device 1100. In its most basic configuration, computing device 1100 typically includes at least one processing unit 1102 and memory 1104. Depending on the exact configuration and type of computing device, memory 1104 may be volatile (such as random access memory (RAM)), non-volatile (such as read-only memory (ROM), flash memory, etc.), or some combination of the two. This most basic configuration is illustrated in FIG. 11 by dashed line 1106.

Computing device 1100 may have additional features/functionality. For example, computing device 1100 may include additional storage (removable and/or non-removable) including, but not limited to, magnetic or optical disks or tape. Such additional storage is illustrated in FIG. 11 by removable storage 1108 and non-removable storage 1110.

Computing device 1100 typically includes a variety of computer readable media. Computer readable media can be any available media that can be accessed by computing device 1100 and include both volatile and non-volatile media, and removable and non-removable media.

Computer storage media include volatile and non-volatile, and removable and non-removable media implemented in any method or technology for storage of information such as computer readable instructions, data structures, program modules or other data. Memory 1104, removable storage 1108, and non-removable storage 1110 are all examples of computer storage media. Computer storage media include, but are not limited to, RAM, ROM, electrically erasable program read-only memory (EEPROM), flash memory or other memory technology, CD-ROM, digital versatile disks (DVD) or other optical storage, magnetic cassettes, magnetic tape, magnetic disk storage or other magnetic storage devices, or any other medium which can be used to store the desired information and which can be accessed by computing device 1100. Any such computer storage media may be part of computing device 1100.

Computing device 1100 may contain communications connection(s) 1112 that allow the device to communicate with other devices. Computing device 1100 may also have input device(s) 1114 such as a keyboard, mouse, pen, voice input device, touch input device, etc. Output device(s) 1116 such as a display, speakers, printer, etc. may also be included. All these devices are well known in the art and need not be discussed at length here.

It should be understood that the various techniques described herein may be implemented in connection with hardware or software or, where appropriate, with a combination of both. Thus, the processes and apparatus of the presently disclosed subject matter, or certain aspects or portions thereof, may take the form of program code (i.e., instructions) embodied in tangible media, such as floppy diskettes, CD-ROMs, hard drives, or any other machine-readable storage medium where, when the program code is loaded into and executed by a machine, such as a computer, the machine becomes an apparatus for practicing the presently disclosed subject matter.

Although exemplary implementations may refer to utilizing aspects of the presently disclosed subject matter in the context of one or more stand-alone computer systems, the subject matter is not so limited, but rather may be implemented in connection with any computing environment, such as a network or distributed computing environment. Still further, aspects of the presently disclosed subject matter may be implemented in or across a plurality of processing chips or devices, and storage may similarly be effected across a plurality of devices. Such devices might include PCs, network servers, and handheld devices, for example.

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims.

What is claimed:

1. A method for graph bisection, comprising:
receiving as input, at a computing device, a graph comprising a plurality of vertices and a plurality of edges;
generating a plurality of subproblems using the graph, by the computing device;
determining a graph bisection using the subproblems and a plurality of combinatorial bounds based on disjoint paths, by the computing device; and
outputting the graph bisection.

2. The method of claim 1, wherein generating the subproblems using the graph comprises decomposing the graph into the subproblems.

3. The method of claim 1, wherein determining the graph bisection using the subproblems comprises solving the subproblems independently.

4. The method of claim 1, wherein determining the graph bisection using the subproblems comprises using a branch-and-bound technique.

5. The method of claim 4, wherein the branch-and-bound technique generates a tree, and further comprising determining an optimum balanced bisection of the vertices of the graph using the tree.

6. The method of claim 5, further comprising determining a lower bound, and pruning the tree using the lower bound.

7. The method of claim 6, wherein the lower bound is an edge-based packing lower bound.

8. The method of claim 6, wherein determining the lower bound comprises:
computing a tree packing comprising a plurality of trees; and
allocating a plurality of vertex weights to the plurality of trees.

9. The method of claim 8, wherein allocating the plurality of vertex weights to the plurality of trees comprises fractionally allocating the vertex weights to the trees.

10. The method of claim 6, further comprising reducing the branch-and-bound tree using forced assignments.

11. The method of claim 1, wherein the graph bisection is a balanced bisection of the vertices of the graph.

12. A method for graph bisection, comprising:
receiving as input, at a computing device, a graph comprising a plurality of vertices and a plurality of edges;
determining an edge-based packing lower bound of the graph, by the computing device;
determining a graph bisection using the edge-based packing lower bound, by the computing device; and
outputting the graph bisection.

13. The method of claim 12, wherein determining the edge-based packing lower bound comprises:
determining a tree packing; and
allocating a plurality of vertex weights to the tree packing.

14. The method of claim 13, where the tree packing comprises a plurality of trees, wherein the trees are edge-disjoint and maximal, and wherein each tree contains exactly one edge incident to a set of vertices already assigned to one of the cells.

15. The method of claim 14, further comprising allocating the vertex weights to the tree packing.

16. The method of claim 13, wherein allocating the plurality of vertex weights to the tree packing comprises fractionally allocating the vertex weights to the tree packing.

17. A system comprising:
at least one computing device; and
a graph bisection component that receives a graph comprising a plurality of vertices and a plurality of edges, decomposes the graph into a plurality of subproblems that can be solved independently and determines a graph bisection using the subproblems and a branch-and-bound technique.

18. The system of claim 17, wherein the graph bisection component is adapted to perform the branch-and-bound technique using partial assignments of the vertices to both cells comprising the bisected graph.

19. The system of claim 17, wherein the branch-and-bound technique generates a tree, determines an edge-based packing lower bound, and prunes the tree using the edge-based lower bound.

20. The system of claim 19, wherein determining the edge-based packing lower bound comprises computing a tree packing comprising a plurality of trees, and allocating a plurality of vertex weights to the plurality of trees.
